(19) United States
(12) Patent Application Publication
(10) Pub. No.: US 2017/0184773 A1
(43) Pub. Date: Jun. 29, 2017

(54) BACKLIGHT MODULE AND LIQUID CRYSTAL DISPLAY DEVICE USING THE SAME

(71) Applicant: SHENZHEN CHINA STAR OPTOELECTRONICS TECHNOLOGY CO., LTD., Shenzhen, Guangdong (CN)

(72) Inventor: Xiaoyu HUANG, Shenzhen, Guangdong (CN)

(21) Appl. No.: 14/416,773

(22) PCT Filed: Dec. 25, 2014
(86) PCT No.: PCT/CN2014/094977

§ 371 Date: Jun. 25, 2015

(30) Foreign Application Priority Data
Sep. 17, 2014 (CN) 201410473106.3

(51) Int. Cl. F21V 8/00

(52) U.S. Cl. CPC G02B 6/0031

(57) ABSTRACT

A backlight module and a liquid crystal display device using the backlight module are provided. The backlight module comprises a backlight source, which includes a plate body provided with a light source lamp, and a reflector arranged on at least one longitudinal edge of the plate body. An inner wall of the reflector forms a reflective surface, which is arranged as extending obliquely away from the light source lamp. The backlight module enables light emitted from the light source lamp to enter the light guide plate to the largest extent, thereby removing the problems of light leakage and low light efficiency. Hence, in a liquid crystal display device using the backlight module, electric current can be reduced while brightness is maintained, thereby achieving the purpose of energy conservation.

### CROSS-REFERENCE TO RELATED APPLICATIONS

The present application claims benefit of Chinese patent application CN 201410473106.3, entitled “Backlight module and liquid crystal display device using the same” and filed on Sep. 17, 2014, the entirety of which is incorporated herein by reference.

### FIELD OF THE INVENTION

The present disclosure relates to a liquid crystal display component, and in particular to a backlight module. The present disclosure further relates to a liquid crystal display device using the backlight module.

### BACKGROUND OF THE INVENTION

Thin film transistor liquid crystal displays (i.e., TFT-LCDs), as one of the major types of current flat-panel displays, are widely used in electronic devices. As liquid crystals do not emit light per se, arrangement of backlight modules is necessary for display. The mainstream backlight modules at present comprise a side backlight source, i.e., a backlight source lamp provided at a side of the backlight module, with which light is transmitted into a display area via a light guide plate. Nonetheless, such backlight module would lead to occurrence of light leakage. In order to solve the problem of light leakage, a shading film has been attached above the light source lamp in the prior art. However, such shading film has a risk of being detached, which would further cause the problems such as occurrence of dark areas on the backlight module, thereby affecting the quality of products.

### SUMMARY OF THE INVENTION

To solve the above technical problems in the prior art, the present disclosure provides a backlight module, which can attenuate light leakage and is free from the problem of a detached shading film. The present disclosure further relates to a liquid crystal display device using the backlight module.

1) According to a first aspect of the present disclosure, a backlight module is provided, comprising a backlight source, which includes a plate body provided with a light source lamp, and a reflector arranged on at least one longitudinal edge of the plate body, wherein an inner wall of the reflector forms a reflective surface, which is arranged as extending obliquely away from the light source lamp.

In the backlight module according to the present disclosure, scattered light exiting from the backlight module, which would lead to the phenomenon of light leakage, can be avoided due to arrangement of the reflector. Thus, the problem of light leakage in the backlight module can be relieved. With this backlight module, a shading film can be omitted also, thus eliminating the problem of a detached shading film. In addition, the reflector can further reflect the scattered light back onto a light guide plate, thereby improving light efficiency.

2) In one embodiment according to item 1) of the present disclosure, the inner wall of the reflector is arranged as extending obliquely away from the light source lamp, and the reflector, in a cross section thereof, has an angle in the range from 25° to 35°, preferably 30°, relative to a normal of the plate body. Moreover, the length of a horizontal component of the length of the reflector equals the sum of a thickness and a coupling distance of the light source lamp. In the present disclosure, the term “the length of a horizontal component of the length of the reflector” refers to the length of the horizontal component of the length of the reflector in a line perpendicular to the plate body. These technical features ensure non-occurrence of light leakage of the backlight module, without affecting the display effects of a display device using the backlight module.

3) In one embodiment according to item 1) or 2) of the present disclosure, the reflective surface is coated with a reflective layer used for further improving reflective efficiency of the scattered light, thereby improving light efficiency.

4) In one embodiment according to any one of items 1) to 3) of the present disclosure, the reflector is formed integrally with the plate body. This indicates the reflector and the plate body form into one piece, thus substantially eliminating the problem of a detached reflector, and further eliminating the problem of dark areas that would otherwise occur on the backlight module due to a detached reflector.

5) In one embodiment according to any one of items 1) to 4) of the present disclosure, the reflector and the plate body are both made of aluminum. Aluminum has superior thermal conductivity, and hence can improve heat dissipation performance of the backlight module.

6) In one embodiment according to any one of items 1) to 5) of the present disclosure, the light source lamp is in the form of a light-emitting diode, which is completely accommodated in a space formed by the reflector and the plate body. This design can guarantee an optimal reflective place for the light-emitting diode.

7) According to a second aspect of the present disclosure, a liquid crystal display device comprising the backlight module as described above is provided. In the liquid crystal display device, electric current can be reduced while the brightness is maintained, thereby achieving the purpose of energy conservation.

Compared with the prior art, the present disclosure has the following advantages. At the outset, the backlight source of the backlight module comprises a plate body provided with a light source lamp, and a reflector arranged at a longitudinal edge of the plate body. The reflector can reflect scattered light onto the light guide plate, thus avoiding light leakage and improving utilization of light. Besides, an inner wall of the reflector forms a reflective surface, which is arranged as extending obliquely away from the light source lamp. Moreover, the reflector has an angle in the range from 25° to 35°, preferably 30°, relative to a normal of the plate body. Furthermore, the length of the reflector has a horizontal component equivalent to the sum of a thickness and a coupling distance of the light source lamp. These technical features ensure non-occurrence of light leakage of the backlight module, without affecting the display effects of a display device using the backlight module. In a liquid crystal display device using the backlight module, electric current can be reduced while brightness is maintained, thereby achieving the purpose of energy conservation.

### BRIEF DESCRIPTION OF THE DRAWINGS

The present disclosure will be described in detail based on embodiments with reference to the accompanying drawings, in which:

FIG. 1 is a structural diagram of a backlight module according to the present disclosure;

FIG. 2 shows a three-dimensional structural view of a backlight source according to the present disclosure; and

FIG. 3 is a view along the direction A as shown in FIG. 2.

In the drawings, the same components are indicated with the same reference signs. The figures are not drawn in accordance with an actual scale.

### DETAILED DESCRIPTION OF THE EMBODIMENTS

The present disclosure will be further explained in conjunction with the accompany drawings.

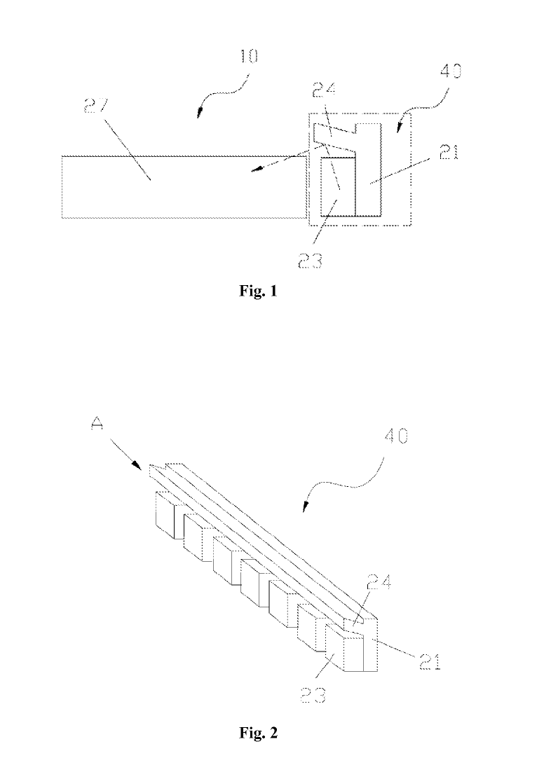

FIG. 1 schematically shows the structure of a backlight module 10 according to the present disclosure. The backlight module 10 comprises a backlight source 40 and a light guide plate 27 arranged right ahead the backlight source 40. The backlight source 40 includes a plate body 21 provided with at least one light source lamp 23, and a reflector 24 arranged at one longitudinal edge of the plate body 21. The reflector 24 is configured to be capable of preventing scattered light from exiting via an interval formed between the plate body 21 and the light guide plate 27, which would otherwise generate the phenomenon of light leakage. In addition, the reflector 24 can further reflect a majority of the scattered light back onto the light guide plate 27, shown by the dashed arrow in FIG. 1, thus significantly improving light efficiency. Hence, when a liquid crystal display device uses the backlight module 10, brightness can be maintained with reduced consumption of electric energy, whereby energy conservation can be achieved.

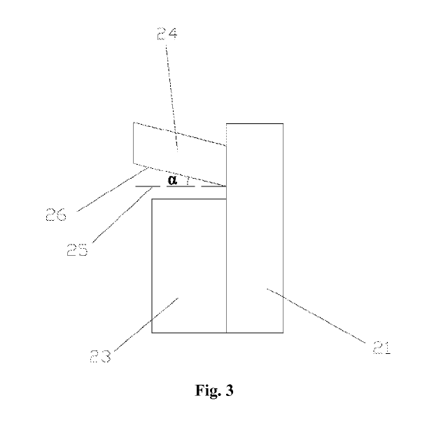

FIG. 2 depicts the structure of the backlight source 40 in a three-dimensional view. The reflector 24 is arranged at one longitudinal edge of the plate body 21 in the backlight source 40, while the light source lamp 23 is mounted in a space formed between the plate body 21 and the reflector 24. An inner surface of the reflector 24 forms a reflective surface 26 as indicated in FIG. 3. In order to improve reflectivity, the reflective surface 26 is further coated with a reflective layer. The plate body 21 and the reflector 24 can both be made of a material having superior thermal conductivity so as to improve heat dissipation performance thereof. In one embodiment, the plate body 21 and the reflector 24 can both be made of aluminum, which has not only excellent thermal conductivity but also low costs. Hence, the production costs thereof can be reduced. In another embodiment, the reflector 24 can be formed integrally with the plate body 21. Such structure can substantially eliminate the possibility for the reflector 24 to be detached, thereby avoiding the problem of dark spots that would otherwise occur on the backlight module 10.

In order to further improve reflective efficiency, an inner wall of the reflector 24 can be further arranged as extending obliquely away from the light source lamp 23. As indicated in FIGS. 2 and 3, the reflector 24 can be configured as a parallelepiped, which has a cross section in the form of a parallelogram. Viewed from the cross section of the reflector 24, as FIG. 3 shows, a side 26 of the parallelogram constitutes the reflective surface of the reflector 24, and is arranged as extending obliquely away from the light source lamp 23 at an angle α relative to a normal of the plate body 21. In one embodiment, the angel α can be in the range from 25° to 35°, preferably 30°. Moreover, the side 26 has a component in a dotted line 25, which equals the sum of a thickness and a coupling distance of the light source lamp 23. This means that the length of reflector 24 has a horizontal component on the dotted line 25 equivalent to the sum of the thickness and the coupling distance of the light source lamp 23. Such being the case, the oblique arrangement of the reflector 24 and the size thereof can ensure complete refection of scattered light onto the light guide plate 27, without affecting the display effects of a display device using the backlight module 10. It should be noted that, although presented as a parallelogram in FIG. 3, the cross section of the reflector 24 is not limited thereto, but can be in any suitable shape that would guarantee a necessary shape and size of the side 26.

The light source lamp 23 can be selected as a light-emitting diode, for example, in the form of a cube as shown in FIG. 2. A cube light-emitting diode can be conveniently mounted, thus facilitating production.

The present disclosure further relates to a liquid crystal display device using the backlight module 10, such as a liquid crystal display screen. The reflector 24 can introduce light from the light source lamp 23 entirely onto the light guide plate 27, and therefore can ensure brightness of the liquid crystal display device with a reduced consumption of electric energy and a reduced size of the light source lamp 23. As a result, the purpose of energy conservation can be realized with reduced production costs.

The inventor of the present disclosure has carried out tests using the backlight module 10. In the tests, the light-emitting diode 23 was selected as having a thickness of 0.8 mm and a coupling distance of 0.4 mm; the reflector 24 was selected as having a thickness of 0.8 mm; the length of the reflector 24 had a horizontal component with a length of 1.38 mm; and the angle α was 30°. The results of the tests showed a 3% increase of the brightness of a liquid crystal display device using the backlight module 10.

Although the present disclosure has been described with reference to preferred embodiments, various modifications and variants to the present disclosure may be made by anyone skilled in the art, without departing from the scope and spirit of the present disclosure. In particular, as long as there is no structural conflict, various embodiments as well as the respective technical features mentioned herein may be combined with one another in any manner. The present disclosure is not limited to the specific embodiments disclosed herein, but rather includes all the technical solutions falling within the scope of the claims.

1. A backlight module, comprising a backlight source, which includes a plate body provided with a light source lamp, and a reflector arranged on at least one longitudinal edge of the plate body, wherein an inner wall of the reflector forms a reflective surface, which is arranged as extending obliquely away from the light source lamp.

2. The backlight module according to claim 1, wherein the reflector, in a cross section thereof, has an angle in the range from 25° to 35° relative to a normal of the plate body.

3. The backlight module according to claim 2, wherein the reflector has an angle of 30° relative to the normal of the plate body.

4. The backlight module according to claim 2, wherein the length of the reflector has a horizontal component equivalent to the sum of a thickness and a coupling distance of the light source lamp.

5. The backlight module according to claim 4, wherein the reflector is formed integrally with the plate body.

6. The backlight module according to claim 5, wherein the reflective surface is coated with a reflective layer.

7. The backlight module according to claim 6, wherein the reflector and the plate body are both made of aluminum.

8. The backlight module according to claim 7, wherein the light source lamp is in the form of a light-emitting diode, which is completely accommodated in a space formed by the reflector and the plate body.

9. A liquid crystal display device, comprising a backlight module, which has a backlight source including a plate body provided with a light source lamp, and a reflector arranged on at least one longitudinal edge of the plate body, wherein an inner wall of the reflector forms a reflective surface, which is arranged as extending obliquely away from the light source lamp.

10. The liquid crystal display device according to claim 9, wherein the reflector, in a cross section thereof, has an angle in the range from 25° to 35° relative to a normal of the plate body.

11. The liquid crystal display device according to claim 10, wherein the length of the reflector has a horizontal component equivalent to the sum of a thickness and a coupling distance of the light source lamp.
